(19) United States
(12) Patent Application Publication
(10) Pub. No.: US 2015/0094869 A1
(43) Pub. Date: Apr. 2, 2015

(54) SYSTEMS, METHODS AND APPARATUS FOR CREATING AN OPERATING SCHEDULE FOR MULTI-STATE GENERATOR RESOURCES

(71) Applicant: Siemens Industry, Inc., Alpharetta, GA (US)

(72) Inventors: Tao Li, Plymouth, MN (US); Ashmin Mansingh, Maple Grove, MN (US)

(73) Assignee: Siemens Industry, Inc., Alpharetta, GA (US)

(21) Appl. No.: 14/250,567

(22) Filed: Apr. 11, 2014

Related U.S. Application Data
(60) Provisional application No. 61/884,537, filed on Sep. 30, 2013.

(51) Int. Cl. G05B 13/04

(52) U.S. Cl. CPC G05B 13/041; G05B 2219/15097
USPC 700/286

(57) ABSTRACT

Embodiments of the invention provide systems, methods, and apparatus for receiving input information including at least one of generator parameters, energy output requirements, fuel cost, fuel availability, and a maintenance schedule; creating a multi-state resource model based on the input information; generating an optimized operating schedule from the multi-state resource model based on the input information; and controlling the multi-state resources to optimally meet energy output requirements using the operating schedule. Numerous other aspects are provided.

### RELATED APPLICATIONS

The present application claims priority to U.S. Provisional Application No. 61/884,537 titled “SYSTEMS, METHODS AND APPARATUS FOR CREATING AN OPERATING SCHEDULE FOR MULTI-STATE GENERATOR RESOURCES” filed Sep. 30, 2013 which is incorporated herein by reference for all purposes.

### FIELD OF THE INVENTION

The present invention relates to scheduling the operation of resources such as power generators, and more specifically to determining an optimal schedule for operating multi-state generator resources.

### BACKGROUND OF THE INVENTION

Optimizing the operation of power generators, particularly those having multiple operating states or power output capabilities, to minimize cost and maximize efficiency is a complex problem. Conventional methods used typically require significant manual calculations that require detailed technical understanding. Thus, what is needed are automated systems, methods, and apparatus for generating optimized operating schedules based on accurate models of such generator systems.

### SUMMARY OF THE INVENTION

In some embodiments, a method of operating multi-state resources is provided. The method includes receiving input information including at least one of generator parameters, energy output requirements, fuel cost, fuel availability, and a maintenance schedule; creating a multi-state resource model based on the input information; generating an optimized operating schedule from the multi-state resource model based on the input information; and controlling the multi-state resources to optimally meet energy output requirements using the operating schedule.

In other embodiments, a system for operating multi-state resources is provided. The system includes a plurality of input information sources; a modeling system including a multi-state resource model operable to generate an operating schedule, the modeling system couplable to the input information sources to receive input information; a system controller operative to execute the operating schedule and coupled to the modeling system; and a plurality of multi-state resources coupled to and controlled by the system controller.

In still other embodiments, an alternative system for operating multi-state resources is provided. The system includes a processor; and a memory coupled to the processor and storing processor executable instructions to: receive input information including at least one of generator parameters, energy output requirements, fuel cost, fuel availability, and a maintenance schedule, create a multi-state resource model based on the input information, generate an optimized operating schedule from the multi-state resource model based on the input information, and control the multi-state resources to optimally meet energy output requirements using the operating schedule.

Numerous other aspects are provided in accordance with these and other aspects of the invention. Other features and aspects of the present invention will become more fully apparent from the following detailed description, the appended claims and the accompanying drawings.

### BRIEF DESCRIPTION OF THE DRAWINGS

FIG. 1 is an example graph depicting the relative accuracy of different modeling methods according to embodiments of the present invention.

FIG. 2 is an example depiction of a multi-state resource model according to embodiments of the present invention.

FIG. 3 is an example depiction of the feasible state transition space for the multi-state resource model of FIG. 2 according to embodiments of the present invention.

FIGS. 4A to 4D are a graphic depiction of four types of configuration transitions according to embodiments of the present invention.

FIG. 5 is a schematic depiction of an example system according to embodiments of the present invention.

FIG. 6 is a flowchart depicting an example method according to embodiments of the present invention.

FIG. 7 is a flowchart depicting details of the example method of FIG. 6 according to embodiments of the present invention.

### DETAILED DESCRIPTION

The present invention provides apparatus and methods for creating an optimized operating schedule for using multi-state resources (MSRs) such as, for example, multi-state generators (MSGs). The modeling of MSG resources in a security constrained unit commitment environment is used by independent system operators and energy generation companies for market clearing and making economic commitments. In addition, such models are used for the dispatch of generators subject to constraints on the power grid. In some embodiments, the present invention also provides improved modeling of units with prohibited operating regions and reduced ramping capability in the real time commitment and dispatch operation. Embodiments of the present invention can be applied to solving MSG resource scheduling in both electricity markets and traditional integrated power utilities.

The present invention provides methods for modeling combined cycle power plants (as a general formulation of multi-stage generation) for mathematical formulation during configuration changes evaluated by a general unit commitment and dynamic dispatch problem requiring optimization of the overall operational cost objective function for use by independent system operators; market participants; generation providers; and vertical utilities managing the commitment and dispatch of their generators. Unit commitment and dynamic dispatch solutions are used in forward and real time electricity markets; outage recovery optimization; market simulation; unit commitment for operational planning; and dynamic dispatch for real-time operations planning.

In general, linear programming (LP) can be used to minimize or maximize a linear cost function subject to linear equality and inequality constraints. In linear programming, all the variables are continuous. Mixed integer programming (MIP) is analogous to linear programming except that some of the variables used are restricted to integer values.

Generally, in linear programming, a more useful formulation is one that has a relatively small number of variables (n) and constraints (m) because the computational complexity of the problem grows polynomially with increasing values of n and m. In addition, given the availability of several efficient algorithms for linear programming, the choice of a formulation, although important, does not critically affect one's ability to solve a problem. However, the situation in mixed integer programming is drastically different. The present inventors have determined from extensive computational experience that the choice of a formulation can be significant in MIP. Strong formulations are central to being able to solve mixed integer programming problems efficiently. For example, a useful formulation may be solvable many times faster than a less useful formulation of an MIP problem.

Linear programming relaxation is similar to MIP but the restriction on integer variables is relaxed by making the integer variables into continuous variables. Note that if an optimal solution to the relaxation of an MIP problem is feasible, the solution is also an optimal solution to the original MIP problem.

The quality of a formulation of an integer programming problem with feasible solution set T, can be judged by the closeness of the feasible set of its linear programming relaxation to the convex hull of T. For example, consider two formulations A and B of the same integer programming problem. If the feasible sets of the corresponding linear programming relaxations are denoted by P(A) and P(B), formulation A can be considered to be at least as strong as formulation B if:

P(A)⊂P(B)

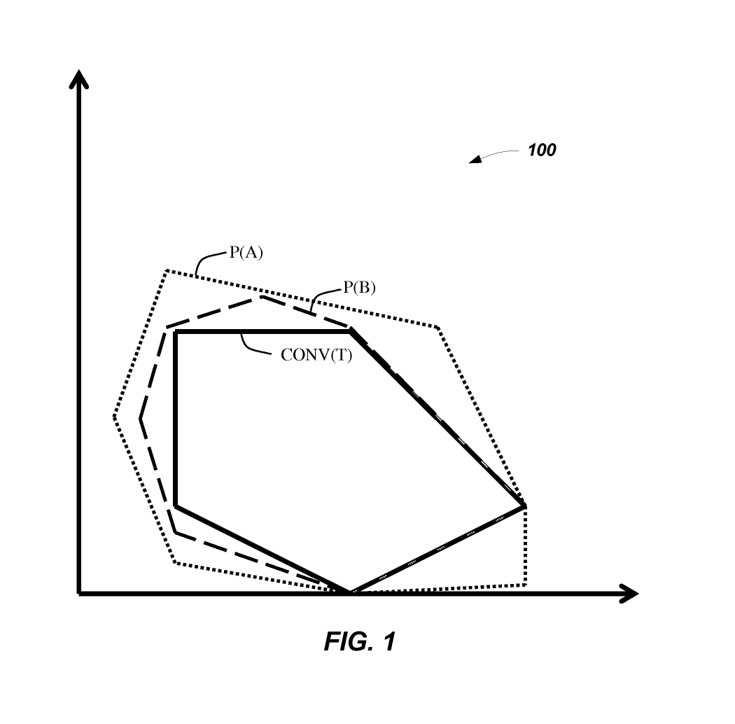

Ideally, the MIP model would be reformulated so that the feasible region of the corresponding LP model becomes the convex hull of feasible integer points of the MIP model. Such a formulation where the LP relaxation gives the convex hull of the LP solution is known as a sharp. Unfortunately, this is often very difficult. In light of this, it is reasonable to build a formulation which is as close as possible to the feasible integer region or the convex hull of the MP problem. The relative strength of different MIP formulations is represented in FIG. 1.

In the graph 100 of FIG. 1, the convex hull of the example MIP problem is the region enclosed by the solid lines labeled CONV(T). The feasible region of the LP relaxation of formulation A is the region enclosed by the dotted lines labeled P(A) while the feasible region of the LP relaxation of formulation B is the region enclosed by the dashed lines labeled P(B). It can be seen that formulation B is better/stronger compared to formulation A since the feasible region of LP relaxation of formulation B is smaller.

There are advantages of MIP over LR. Traditionally, the scheduling of MSG resources is solved by the Lagrangian relaxation (LR) method. However, the disadvantages of the LR method include: lack of global optimality; lack of direct measure of the optimality of a solution; difficulty of considering a large number of constraints like transmission constraints; and difficulty of adding new constraints and maintenance.

In contrast, the MIP method can guarantee a solution that is globally optimal or one within an acceptable tolerance. The relative gap in MIP represents the absolute relative distance between the best integer solution and the best LP solution. The best LP solution is the solution of the LP relaxation of the corresponding MIP problem by relaxing integer variables as continuous variables. Accordingly, the MIP method could guarantee that the best integer solution is within the corresponding MIP gap of the globally optimal solution. Because of the nonconvexity of the unit commitment problem, the LR solution is near optimal. Heuristics are often required to find a feasible solution. The MIP approach can model constraints and cost functions more accurately and easily. Adding constraints in MIP does not require modifications to the solution algorithm as would be required using the LR method. The present invention uses an MIP based approach to solve the scheduling of multi-state generator resource.

In graph theory, a flow network (also known as a transportation network) is a directed graph where each edge has a capacity and each edge receives a flow. The amount of flow on an edge cannot exceed the capacity of the edge. Often in Operations Research, a directed graph is called a network, the vertices are called nodes and the edges are called arcs. A flow must satisfy the restriction that the amount of inflow into a node should equal the amount of flow out of it. A network can be used to model traffic in a road system, fluids in pipes, currents in an electrical circuit, or anything similar in which something travels through a network of nodes.

An MSG model according to embodiments of the present invention applies to resources with more than two operating states and is an extension of the two-state (on/off) model for generating units. Examples of MSG resources are the Combined Cycle Gas Turbine (CCGT) resources and generating units with multiple operating ranges. In some embodiments, a resource with prohibited or forbidden operating regions can be modeled as a multi-state resource. An embodiment of an MSG model includes a specified number of discrete states (one off state and at least two on states with different configurations). Each state represents a configuration in which the MSG resource can operate. Specifically, each state is identified by an integer variable. State 0 denotes the off-line state and states 1 through n denote the various operating states. Operating limits and technical characteristics are defined for each state separately. In fact, each state is modeled as a logical generator referred to as a MSG Configuration with its own operating limits, ramp rate functions, minimum load cost, and energy bids.

The constraints facing a MSG resource are mutually exclusive of operating modes (configurations) at any time interval: the MSG resource can operate in only one of the modes or offline at any particular time; have a feasible transition matrix where one configuration may only be able to transit to certain configurations of the MSG resource and is infeasible to transit to certain configurations; include a transition time that defines how much time it takes to finish a transition; include a notification time that defines the time needed to send transition instructions to MSG operators before the complete of transition; include a transition cost/startup cost that defines the cost associated with transition from one configuration to another or from offline state to one configuration; do not include a transition at the end of scheduling period; include a minimum up/down time of MSG configurations including minimum up/down time of MSG plant; include a maximum number of transitions or start-ups; include ramping constraints during transition where one configuration will have to reach certain MW level to perform a transition; include a transition profile/startup profile which is the MW dispatch during transition or startup; and resource capacity constraints.

Embodiments of the present invention provide an MIP-based approach to model all the constraints faced by MSG resources. A process to model each possible transition is provided by defining one binary variable with 1 indicating the transition will happen while 0 means the transition will not happen. Each transition is defined as the MSG resource moving from one time interval to the next time interval, which includes the transition from one configuration to a different configuration, one configuration to itself, the MSG resource offline mode to one configuration (startup of the MSG resource), and one configuration to offline (shutdown of the MSG resource). There are many ways to model the MSG transition by defining different binary and continuous variables. However, some methods can result in formulations involving both integer and continuous variables. Those formulations can be solved by mixed-integer programming and each formulation will result in very different solution speed. A more useful formulation would be that the MIP problem can be solved by just using LP. The present invention defines such a more useful formulation, i.e., a sharp formulation.

The MSG model includes a prescribed set of feasible transitions among the states. State transitions may be unidirectional or omnidirectional. Undefined state transitions are not permissible. Feasible transitions between the various states are also defined with the associated transition properties. The feasible transitions have specified minimum on-state time, minimum off-state time, transition times and costs. This model is an extension of the two-state on/off generating unit model where the start-up time is the off->on transition time, the start-up cost is the off->on transition cost, the minimum down time is the off-state minimum time, and the minimum up time is the minimum on-state time. Furthermore, a maximum number of daily state transitions can be included in the constraints as a generalization of the maximum number of daily start-ups.

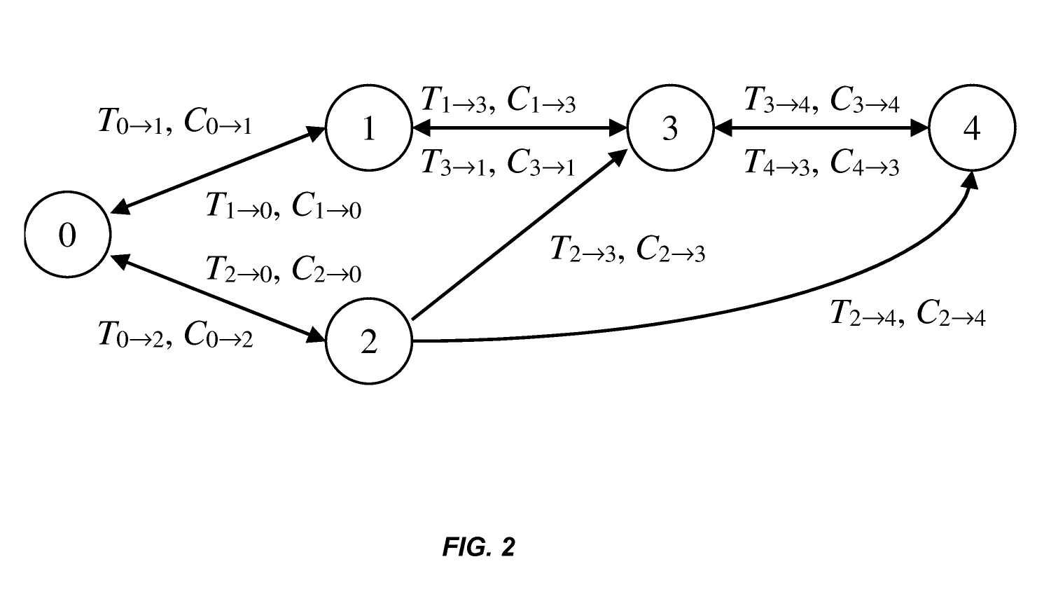

FIG. 2 illustrates an example of a 5-state resource model where T is the state transition time and C the state transition cost. Note that the resource may start-up in configuration 1 or 2 and that the permissible state transition paths are 0 [symbol] 1 [symbol] 3 [symbol] 4, 0 [symbol] 2→3 [symbol] 4, and 0 [symbol] 2→4, i.e., there is no transition from state 4 or 3 to state 2.

The basic idea is that the feasible state transition space is modeled by defining additional binary variables: transition indicator G_{i,j,t}. For a MSG resource with 1 CT and 1 ST, assume that the resource has 3 states: 0 (0 CT, 0 ST), 1 (1 CT, 0 ST), and 2 (1 CT, 1 ST). Also assume that the transition time from state 1 to state 2 are one time interval, and all the other transitions could be completed instantly. The minimum on/off time for each state is one interval. The feasible transition matrix for a MSG resource can be represented in a table as follows:

| | 0 (0 CT, 0 ST) | 1 (1 CT, 0 ST) | 2 (1 CT, 1 ST) |
|---|---|---|---|
| 0 (0 CT, 0 ST) | 1 | 1 | |
| 1 (1 CT, 0 ST) | 1 | 1 | 1 |
| 2 (1 CT, 1 ST) | 1 | 1 | 1 |

Assuming that the MSG resource is initially offline, the feasible state space for a 5-interval period is shown in FIG. 2.

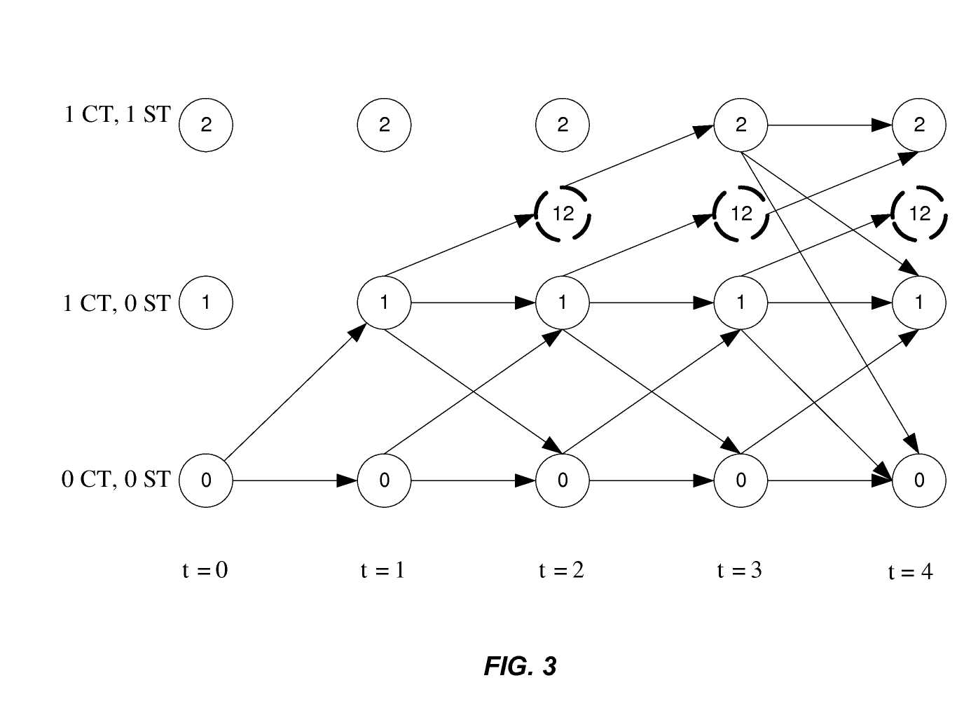

FIG. 3 depicts the feasible state transition space for a MSG resource. As shown, state 12 in dashed circles is the transition state from configuration 1 to 2 because of the two interval transition time. The transition time and transition profile make the problem significantly more complex as the transition state would have to be modeled.

For configuration i, the system can only transit to a few feasible states and the FROM transition constraint is:

$$FRTR \text{:} {Y}_{i , t} = {\sum }_{j ∈ FROM ( i )} {G}_{i , j , t + 1} ∀ k , i , t$$

For configuration i, only a few feasible states can transit to it and the TO transition constraint is:

$$TOTR \text{:} {\sum }_{j ∈ TO ( i )} {G}_{j , i , t - {TT}_{j , i}} = {Y}_{i , t} ∀ k , i , t$$

For the example in FIG. 2, we would have the following equations:

For t=0:

FRTR(0, 0): Y_{0,0}=G_{0,0,1}+G_{0,1,1}

TOTR(0, 0): 1=Y_{0,0}

For t=1:

FRTR(0,1): Y_{0,1}=G_{0,1,2}+G_{0,0,2}

FRTR(1, 1): Y_{1,1}=G_{1,2,2}+G_{1,1,2}+G_{1,0,2}

TOTR(0, 1): G_{0,0,1}=Y_{0,1}

TOTR(1, 1): G_{0,1,1}=Y_{1,1}

For t=2:

FRTR(0,2): Y_{0,2}=G_{0,0,3}+G_{0,1,3}

FRTR(1,2): Y_{1,2}=G_{1,0,3}+G_{1,1,3}+G_{1,2,3}

TOTR(0,2): G_{0,0,2}+G_{1,0,2}=Y_{0,2}

TOTR(1,2): G_{0,1,2}+G_{1,1,2}=Y_{1,2}

For t=3:

FRTR(0,3): Y_{0,3}=G_{0,1,4}+G_{0,0,4}

FRTR(1,3): Y_{1,3}=G_{1,2,4}+G_{1,1,4}+G_{1,0,4}

FRTR(2,3): Y_{2,3}=G_{2,2,4}+G_{2,1,4}+G_{2,0,4}

TOTR(0,3): G_{0,0,3}+G_{1,0,3}=Y_{0,3}

TOTR(1,3): G_{0,1,3}+G_{1,1,3}=Y_{1,3}

TOTR(2,3): G_{1,2,2}=Y_{2,3}

For t=4:

TOTR(0,4): G_{0,0,4}+G_{1,0,4}+G_{2,0,4}=Y_{0,4}

TOTR(1,4): G_{0,1,4}+G_{1,1,4}+G_{2,1,4}=Y_{1,4}

TOTR(2,4): G_{1,2,3}+G_{2,2,4}=Y_{2,4}

Transition time constraints are implicitly modeled in the feasible state space for the MSG resource.

Transition cost is represented as:

$$MIP\_obj += {\sum }_{i ∈ CC ( k )} {\sum }_{j ∈ FROM ( i )} {TC}_{i , j} \cdot {G}_{i , j , t}$$

A transition profile/startup profile can be created. All the MW profiles including the transition, startup profile can be modeled as transition profiles:

$$TRPF \text{:} {PTR}_{i , t} = {\sum }_{j ∈ FROM ( i )} {\sum }_{m = 0}^{{TT}_{ij} - 1} {PTR}_{i , j , m} \cdot {G}_{i , j , t - m} ∀ i , t$$

In an example of a transition profile, assume that configuration i can transit to configuration j for 3 time intervals, and the transition profile for the 3 intervals are 300 MW, 200 MW, 100 MW, respectively. One can formulate the transition MW for interval t. If the transition from configuration i to configuration j starts at t, then PTR_{i,t}=300 MW. If the transition from configuration to configuration starts at t−1, then PTR_{i,t}=200 MW. If the transition from configuration i to configuration j starts at t−2, then PTR_{i,t}=100 MW. So, the possible transition MW contributed by transition from configuration i to configuration j is:

PTR_{i,t}=300·G_{i,j,t}+200·G_{i,j,t-1}+100·G_{i,j,t-2}

as it is not known when the transition from configuration i to configuration j would happen. Also it is not known which transition would happen, so the summation of the transition MW over all the possible transitions would be the transition MW for the MSG at interval t as shown in TRPF. Note that the transition energy will go to load balance, transmission, and energy limit constraints.

There is no transition at the end of the scheduling period. All the transition variables G_{i,j,t} would be set to 0 if they cannot complete the transition to a configuration before the end of the scheduling period. A self-schedule is submitted for only a configuration, but the optimization could commit the MSG resource to a different configuration. One could extend the self-schedule to all configurations.

An extreme scenario with the above modeling is that the whole plant could be shut-off for economic reasons (e.g., uneconomic adjustment). If the plant has to be in startup status, the feasible state space would eliminate those transitions leading to shutdown of the plant.

The energy limit constraint can be represented as:

$$LIMEN : Lim {En}_{k}^{m i n} \leq {\sum }_{i ∈ CC ( k )} {\sum }_{t = 1}^{T} {p}_{i , t}^{En} \leq Lim {En}_{k}^{m ax} , ∀ k$$

wherein the variables include:
p_{i,t}^{En} Generation of configuration i in time step t
   And wherein the constants include:
LimEnₖ^{max} Maximum daily energy limit for MSG resource k
LimEnₖ^{min} Minimum daily energy limit for MSG resource k
T Maximum number of time steps in the scheduling horizon

Ancillary Service (AS) procurement can be represented. The requirement that no AS is procured when in the state of transition is satisfied by the model automatically. There is one additional requirement mutually exclusive of awarding non-spin to multiple configurations:

$$NSPE \text{:} {uy}_{k , t} \leq {Y}_{k , t} , ∀ k$$

$$NSCE \text{:} {\sum }_{i ∈ CC ( k )} {uy}_{i , t} = {uy}_{k , t} , ∀ k$$

$$NSXE \text{:} {uy}_{k , t} + {Z}_{k , t} \leq 1 , ∀ k$$

wherein the variables include:
Y_{k,t} Indicator of off-line configuration status for MSG resource k in time step t (1 means that the off-line configuration is online (MSG plant is offline); 0 means that the offline configuration is offline (MSG plant is online))
uy_{i,t} Indicator of configuration i providing offline non-spinning reserve in time step t
Z_{k,t} Indicator of off-line configuration for MSG resource k starts in time step t (1 means that the off-line configuration is started (MSG plant is offline); 0 means that the offline configuration is not started (MSG plant is online))
uy_{k,t} Indicator of MSG resource k providing offline non-spinning reserve in time step t

Notification time is considered. The feasible state space would be modified to consider the notification time. That is, for those transitions that cannot be completed within the notification time would be forced to be unavailable.

The maximum number of start-ups can be considered. Only those transitions that are from off-line to online configurations would be counted as startups.

$$STU 4 : {\sum }_{t} {G}_{i , j , t} \leq {Max\_StartUps}_{k} , ∀ k$$

wherein the variables include:
G_{i,j,t} Indicator for transition from offline configuration i to j starts in time step t
   and wherein the constants include:
Max_StartUpsₖ Maximum number of startups for MSG resource k
   where these transitions only include transitions from offline-configuration to on-line configuration.

The Min on/off time limits can be considered. The min on/off time limit is enforced at both the plant and configuration level. The min on/off time limit at the MSG plant level would be enforced similarly to those constraints for regular market resource. This would be enforced on the off-line configuration. That is, the minimum on time of the plant would be the minimum off time limit for the off-line configuration and the minimum off time limit would be the minimum online time limit for the off-line configuration.

Configuration level constraints include Min on/off time limits. The min on/off time limit is enforced at both the plant and configuration level. The min on/off time limit at the MSG plant level would be enforced similarly to those constraints for regular market resource.

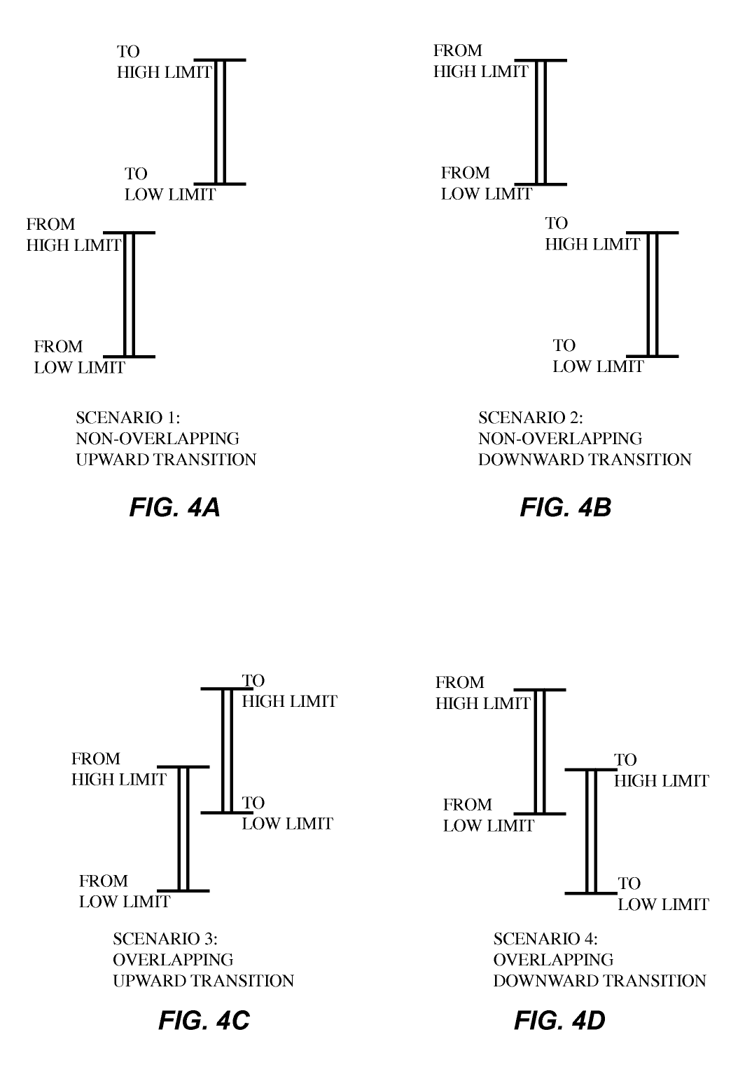

Configuration level constraints also include Ramping constraints. When in the state of transition from one configuration to another, the transition profile would be used. However, The MW of the adjacent intervals of the transition intervals could be anywhere in the ramp feasible range of the configuration. Note that this ramping capacity will be calculated based on half-time interval. Four types of configuration transitions can occur as shown in FIGS. 4A-4D.

The transition ramping limit is modeled where the “from” and “to” configurations stay in half-time interval ramping limits. The “from” configuration for non-over-lapping transition would stay within the limit from resource maximum MW to resource maximum MW minus half-time interval ramping when in upward transition (scenario 1, FIG. 4A) and the limit from resource minimum MW to resource minimum MW plus half-time interval ramping when in downward transition (scenario 2, FIG. 4B); for over-lapping transition, from configuration would stay within the limit from resource maximum MW to resource maximum MW minus half-time interval ramping when in upward transition (scenario 3, FIG. 4C) and the limit from resource minimum MW to resource minimum MW plus half-time interval ramping when in downward transition (scenario 4, FIG. 4D).

The “to” configuration for non-over-lapping transition would stay within the limit from resource minimum MW to resource minimum MW plus half-time interval ramping when in upward transition (scenario 1, FIG. 4A) and the limit from resource maximum MW to resource maximum MW minus half-time interval ramping when in downward transition (scenario 2, FIG. 4B); for over-lapping transition, to configuration would stay within the limit from resource minimum MW to resource minimum MW plus half-time interval ramping when in upward transition (scenario 3, FIG. 4C) and the limit from resource maximum MW to resource maximum MW minus half-time interval ramping when in downward transition (scenario 4, FIG. 4D).

The idea is that there are multiple shutdown ramping limits for the “from” configuration and multiple startup ramping limits for the “to” configuration. The ramping up/down constraints are modified as follows. The sets of transitions for configuration i are divided into four sets based on the four types in FIGS. 4A to 4D:

FROM₁(i)/TO₁(i) (corresponding to scenario 1, FIG. 4A),

FROM₂(i)/TO₂(i) (corresponding to scenario 2, FIG. 4B),

FROM₃(i)/TO₃(i) (corresponding to scenario 3, FIG. 4C), and

FROM₄(i)/TO₄(i) (corresponding to scenario 4, FIG. 4D).

$$ORLU \text{:} {p}_{i , t}^{En} \leq {p}_{i , t - 1}^{En} + {RRL}_{op , i}^{Up} \cdot ( 1 - {Z}_{i , t} ) + {\sum }_{j ∈ {TO}_{1} ( i ) , {TO}_{3} ( i )} ( {p}_{i , t}^{m i n} + 0.5 \cdot {RRL}_{op , i}^{Up} ) \cdot {G}_{j , i , t - {TT}_{j , i}} + {\sum }_{j ∈ {TO}_{2} ( i ) , {TO}_{4} ( i )} {p}_{i , t}^{m a x} {G}_{j , i , t - {TT}_{j , i}}$$

$$ORLU 2 \text{:} {p}_{i , t}^{En} \geq {\sum }_{j ∈ {TO}_{2} ( i ) , {TO}_{4} ( i )} ( {p}_{i , t}^{m ax} - 0.5 \cdot {RRL}_{op , i}^{Up} ) \cdot {G}_{j , i , t - {TT}_{j , i}} ∀ i , t$$

$$ORLD \text{:} {p}_{i , t}^{En} \geq {p}_{i , t - 1}^{En} - {RRL}_{op , i}^{Dn} \cdot ( 1 - {X}_{i , t} ) - {\sum }_{j ∈ {TO}_{2} ( i ) , {TO}_{4} ( i )} ( {p}_{i , t}^{m i n} + 0.5 \cdot {RRL}_{op , i}^{Dn} ) \cdot {G}_{j , i , y - {TT}_{j , i}} - {\sum }_{j ∈ {TO}_{1} ( i ) , {TO}_{3} ( i )} {p}_{i , t}^{m a x} \cdot {G}_{j , i , y - {TT}_{j , i}} \\ ORLD 2 \text{:} {p}_{i , t - 1}^{En} \geq {\sum }_{j ∈ {TO}_{1} ( i ) , {TO}_{3} ( i )} ( {p}_{i , t}^{m ax} - 0.5 \cdot {RRL}_{op , i}^{Dn} ) \cdot {G}_{j , i , t - {TT}_{j , i}} ∀ i , t$$

wherein the variables include:
p_{i,t}^{En} Generation of configuration i in time step t
Y_{i,t} Status of configuration i in time step t
G_{i,j,t} Indicator for transition from configuration i to j starts in time step t
PTR_{i,t} Total transition MW power for MSG configuration i in time step t
Z_{i,t} Indicator for configuration i starts in time step t
   And wherein the constants include:
op_{i,j}^{max} Upper bound of the overlapping range for transition configuration i to j.
op_{i,j}^{min} Lower bound of the overlapping range for transition configuration i to j.
TC_{i,j} Transition cost from configuration i to j.
TT_{i,j} Transition time from configuration i to j.
PTR_{i,j,m} Transition MW power for segment m in transition profile from configuration i to j
RRL_{op,i}^{UP} Operating ramping up limit of configuration i
RRL_{op,i}^{Dn} Operating ramping up limit of configuration i
p_{i,t}^{max} Maximum generation limit of configuration i in time step t
p_{i,t}^{min} Minimum generation limit of configuration i in time step t
LimEnₖ^{max} Maximum daily energy limit for MSG resource k
LimEnₖ^{min} Minimum daily energy limit for MSG resource k
T Maximum number of time steps in the scheduling horizon
   And wherein the sets include:
CC(k) Set of configurations for MSG resource k.
FROM(i) Set of configurations that configuration i can transit to.
FROM₁(i) Set of configurations that configuration i can transit to and transition is non-overlapping upward.
FROM₂(i) Set of configurations that configuration i can transit to and transition is non-overlapping downward.
FROM₃(i) Set of configurations that configuration i can transit to and transition is overlapping downward.
FROM₄(i) Set of configurations that configuration i can transit to and transition is overlapping downward.
TO(i) Set of configurations that can transit to configuration i.
TO₁(i) Set of configurations that can transit to configuration i and transition is non-overlapping upward
TO₂(i) Set of configurations that can transit to configuration i and transition is non-overlapping downward
TO₃(i) Set of configurations that can transit to configuration i and transition is overlapping upward
TO₄(i) Set of configurations that can transit to configuration i and transition is overlapping downward

The above constraints form a network flow problem where the summation of inflow (e.g., transition variables) will be equal the summation of outflow at each node. A MIP formulation which forms a network flow problem has been proven to yield a sharp formulation. The MSG model for the objective function and the first seven constraints listed above (i.e., mutually exclusive of operating modes (configurations) at any time interval: the MSG resource can operate in only one of the modes or offline at any particular time; have a feasible transition matrix where one configuration may only be able to transit to certain configurations of the MSG resource and is infeasible to transit to certain configurations; include a transition time that defines how much time it takes to finish a transition; include a notification time that defines the time needed to send transition instructions to MSG operators before the complete of transition; include a transition cost/startup cost that defines the cost associated with transition from one configuration to another or from offline state to one configuration; do not include a transition at the end of scheduling period; include a minimum up/down time of MSG configurations including minimum up/down time of MSG plant) result in a sharp formulation. Without the remaining constraints the MSG formulation would be a sharp formulation, e.g., the MSG scheduling problem can be solved as an LP problem. This is significant for an MIP formulation although the inclusion of the remaining constraints in the overall MIP model causes the formulation to not be sharp. However, the present invention's approach to define the transition binary variables makes the modeling of the remaining constraints significantly easier and the resulting overall formulation is much tighter. This enables the overall MIP problem to be solved efficiently.

In practical terms, there is a time limit or market timeline for solving the MSG scheduling problem. Thus it is important to solve the scheduling problem quickly and obtain a very good solution. The MSG model of the present invention can achieve this. In addition, the ability of the MSG model to be solved quickly makes it possible to model more constraints associated with MSG resources and other system/resource level constraints so that the model is as close as possible to the practical problem so that the schedule obtained from the overall unit commitment and dispatch problem including MSG model can be utilized directly for operators to dispatch resources and save costs.

To build the MIP model for a MSG resource, a validation process is introduced to filter out all the infeasible transitions considering all constraints. Only the possible feasible transition path is allowed to be used to formulate the MIP model, which significantly reduces the feasible state space and the number of binaries needed to model the MSG resource scheduling.

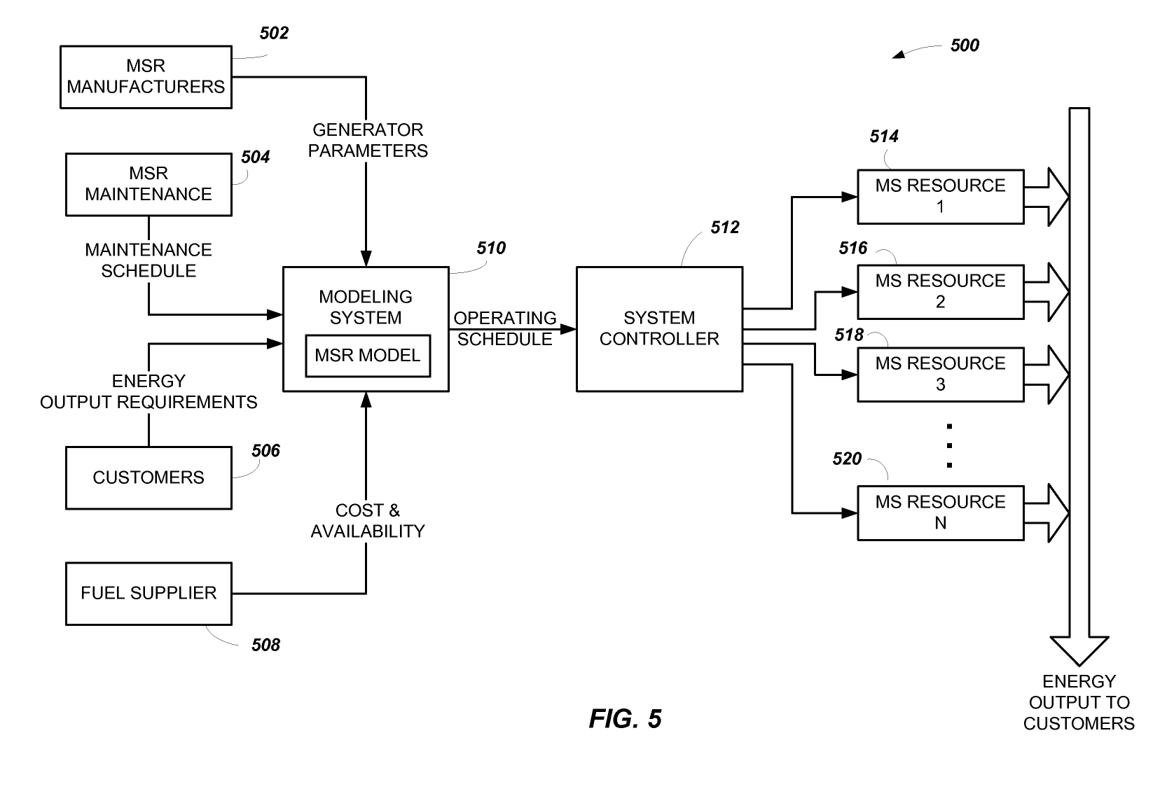

Turning now to FIG. 5, a schematic diagram of an embodiment of a system 500 is provided. The system 500 includes a plurality of data sources including multi-state resource (MSR) manufacturers 502, MSR maintenance requirements 504, customers 506, and fuel suppliers 508. Each data source provides information to the modeling system 510 which includes a MSR model 510 representing the MSGs as described above. The MSR model 510 is used to create an operating schedule which is provided to a system controller 512 that is operably coupled to the MSRs 514-520 and are in turn coupled to output electricity to customers.

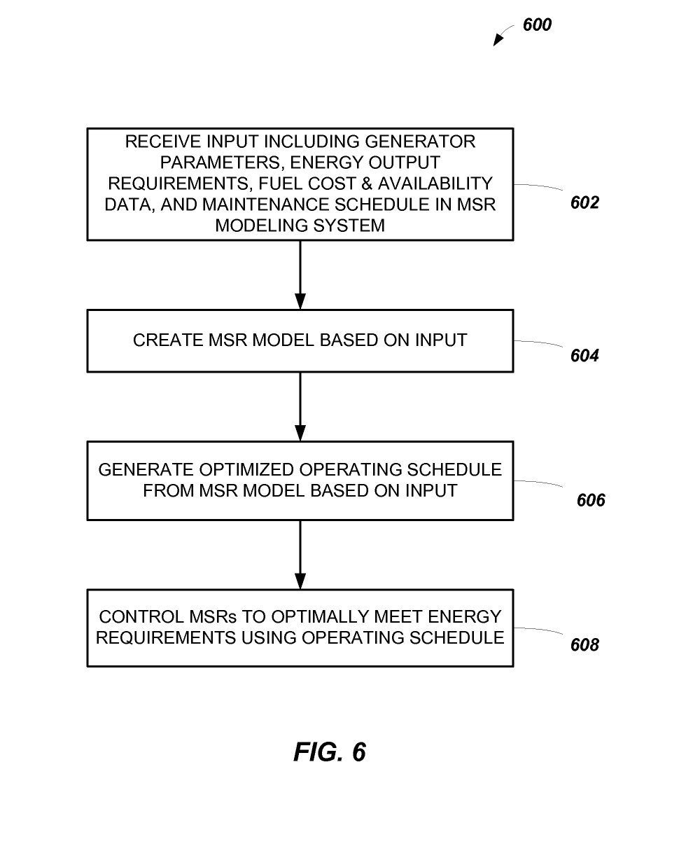

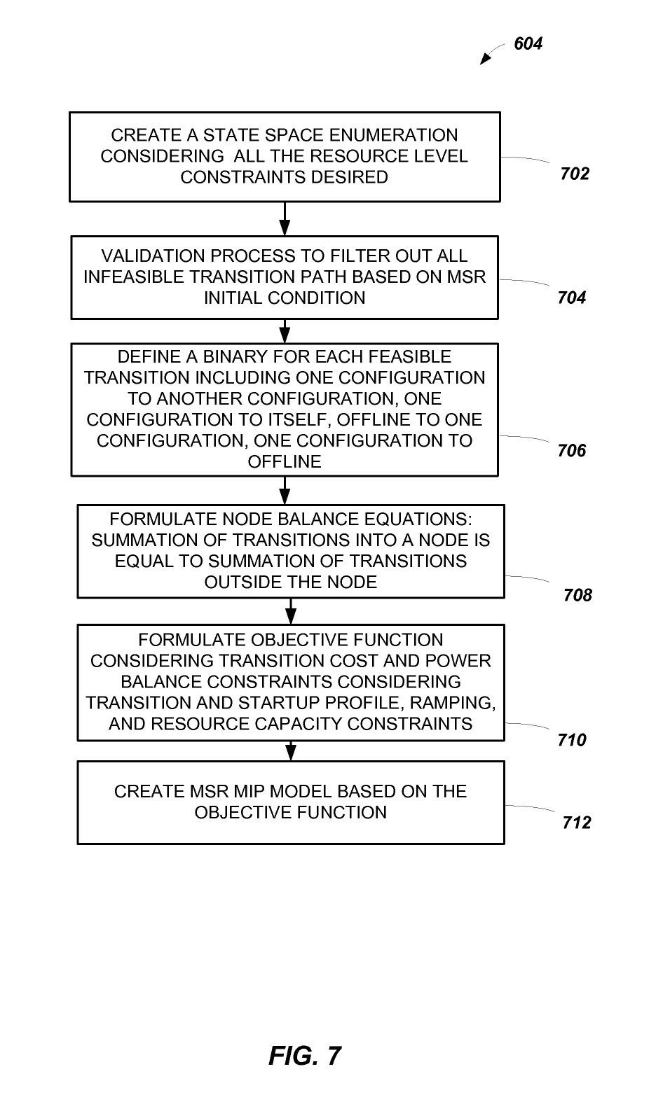

FIG. 6 depicts an example of a method 600 according to embodiments of the present invention. Initially, input data including generator parameters, energy output requirements, fuel cost and availability data, and maintenance schedule is received in the MSR modeling system (602). The MSR model is then created based on the input data (604). Details of the model creation are provided below with respect to the flowchart of FIG. 7. Using the model, an operating schedule is then generated (606). Finally, the MSRs are controlled based upon the operating schedule to optimally meet the energy requirements of the customers (608).

FIG. 7 depicts an example method 604 of creating the MSR model according to embodiments of the present invention. The description is a summary of the process described in detail above with respect to a specific example (FIG. 2). A state space is enumerated and defined that considers all the resource level constraints desired (702). For example, the constraints can include: 1) mutually exclusive configurations at any interval 2) a feasible transition matrix 3) transition time 4) notification time 5) no transition at the end of scheduling period 6) minimum up/down time of MSG configurations and msg plant 7) maximum number of transitions and startups 8) ramping constraints inside a configuration and in transition 9) resource capacity constraints 10) availability and maintenance schedule of MSRs.

A validation process is used to filter out all infeasible transition paths based on the MSR initial conditions (704). A binary value is then defined for each feasible transition including one configuration to another configuration, one configuration to itself, offline to one configuration, and one configuration to offline (706). Next, node balance equations are formulated by setting the summation of transitions into a node equal to the summation of transitions out of the node (708). An objective function is formulated that considers the transition cost and power balance constraints as well as transition and startup profile, ramping, and resource capacity constraints (710). The MSR MIP model is created as described above based on the objective function (712).

Although in some embodiments, the above described methods and systems for operating MSG resources can be applied to resources that have “prohibited” operating regions (e.g., operating modes that are undesirable, inefficient, not cost effective, or the like) by treating each prohibited operating region as another state, alternative embodiments provide a more cost effective solution specific to the problem presented by prohibited operating regions. Further, these embodiments allow the problem to be modeled in real time for significantly enhanced performance. Thus, in alternative embodiments, the present invention can provide a solution to optimally operate MSRs that have prohibited operating regions or “forbidden zones.” The alternative embodiments provide real time models for solving the forbidden zone problem. Where certain assumptions or approximations are not needed and the model uses fewer constraints, which speed the performance, the following methods can be used.

A forbidden zone (FZ), forbidden operating region (FOR), or forbidden region is specified as a pair of lower and higher operating levels between which a resource may not operate stably. FZs lie between the resource minimum and maximum operating limits and they do not overlap. The generating unit is not scheduled within the FZ unless it is operating at a full ramp rate in clearing the FZ with specific ramp rates for the FZ different from the operational ramp rates. That is, if a resource can ramp through a forbidden region within one time step (short FZ), it will never be dispatched within that forbidden region. If it takes multiple time steps for a resource to ramp through a forbidding region (long FZ), the resource will have to cross the forbidden region at full ramping rate and cannot reverse the direction. (For instance, if a resource is ramping up to clear the forbidden region, then it will not be able ramp down inside the forbidden region. Once it crosses out of the forbidden region, it will be able to ramp up or down depending system conditions.) The whole operating range of a resource with forbidden zones will be divided into multiple zones/regions including normal operating regions and forbidden operating regions.

For instance, consider a resource with an operating range from 100 MW to 700 MW with two forbidden operating regions from 320 MW to 400 MW and from 550 MW to 650 MW, respectively. The whole operating range will be divided into 5 regions, including normal operating regions: region 1 from 100 MW to 320 MW, region 3 from 400 MW to 550 MW, region 5 from 650 MW to 700 MW, and forbidden operating regions: region 2 from 320 MW to 400 MW and region 4 from 550 MW to 650 MW.

One binary indicator FZN_{i,j,t} is defined for each region j including normal and forbidden operating regions with 1 indicating the resource i is operating in the specific region in time step t and 0 otherwise. To model the short FZ, the binary indicator variable FZN_{i,j,t} is set to be 0 since a resource will never be dispatched within a short FZ. The following detailed formulation is to model the long FZ. Two continuous variables SL_{i,k,t} and SR_{i,k,t} are defined indicating start of a forbidden zone (FZ) from left/right and model the whole FZ ramping limit instead of single interval ramping limit.

0. Summation of FZ regions below and above k:

$$FRRS \text{:} {FZR}_{i , k , t} = {\sum }_{j \geq k + 1} {FZN}_{i , j , t}$$

$$FRLS \text{:} {FZL}_{i , k , t} = {\sum }_{j \leq k - 1} {FZN}_{i , j , t}$$

$$0 \leq {FZL}_{i , k , t} , {FZR}_{i , k , t} \leq 1$$

wherein the variables include:
FZN_{i,j,t} Indicator for whether resource i operates within region j in time step t
FZR_{i,k,t} Summary of region status variables for regions above forbidden operating region k in time step t
FZL_{i,k,t} Summary of region status variables for regions below forbidden operating region k in time step t

1. Start of FZ k from right:

If a resource enters FZ k from the right/upper side, then SR_{i,k,t} will be forced to be 1 and 0 otherwise.

FRER: SR_{i,k,t}≧2·FZN_{i,k,t}−FZR_{i,k,t-1}−2·(FZN_{i,k,t-1}+FZL_{i,k,t-1})

0≦SR_{i,k,t}≦1

wherein the variables include:
SR_{i,k,t} A continuous variable to indicate whether resource i will cross the forbidden region k from right side (upper regions) in time step t

2. Start of FZ k from left:

If a resource enters FZ k from the left/lower side, then SL_{i,k,t} will be forced to be 1 and 0 otherwise.

FREL: SL_{i,k,t}≧2·FZN_{i,k,t}−FZL_{i,k,t-1}−2·(FZN_{i,k,t-1}+FZR_{i,k,t-1})

0≦SL_{i,k,t}≦1

wherein the variables include:
SL_{i,k,t} A continuous variable to indicate whether resource i will cross the forbidden region k from left side (lower regions) in time step t

3. Relationship between SL_{i,k,t} and SR_{i,k,t} for FZ k:

A resource can only enter the FZ either from right/upper side or left/lower side of FZ k.

FRST: SL_{i,k,t}+SR_{i,k,t}≦FZN_{i,k,t}

4. FZ ramping limit for FZ k:

The idea here is to enforce full ramping inside FOR and make a resource stay inside FOR as less number of intervals as possible because FOR is an unstable operating range. For example: assume a resource has 30 min crossing time in applications with time step length of 15 mins, Tup_{i,k} and Tdn_{i,k} will be 2, i.e., the resource will have to stay inside the FZOR region for two intervals no matter how the resource will step inside the FOR region.

FRRU: p_{i,t+Tup}_{_{i,k}}₋₁−p_{i,t}≧(Tup_{i,k}−1)·ΔP_{i,k}·SL_{i,k,t}−p_{i,t}^{max}·(1−SL_{i,k,t})

FRRD: −p_{i,t+Tdn}_{_{i,k}}₋₁+p_{i,t}≧(Tdn_{i,k}−1)·ΔP_{i,k}·SR_{i,k,t}−p_{it+Tdn}_{_{i,k}}^{max}·(1−SR_{i,k,t})

wherein the constants include ΔP_{i,k}=RRL_{i,k}^{Up}=RRL_{i,k}^{Dn} is the maximum ramp up and down across the forbidden zone k and

$${Tup}_{i , k} = ⌈ \frac{{P}_{i , k}^{m ax} - {P}_{i , k}^{m i n}}{{RRL}_{i , k}^{up}} ⌉ , {Tdn}_{i , k} = ⌈ \frac{{P}_{i , k}^{m ax} - {P}_{i , k}^{m i n}}{{RRL}_{i , k}^{dn}} ⌉$$

where Tup_{i,k}, Tdn_{i,k} are round up values of FZ crossing time in terms of scheduling time intervals and P_{i,k}^{max}, P_{i,k}^{min} are the upper and lower capacity of forbidden region k.

5. Exit FZ k:

A resource will have to exit the FZ once insider the FOR after the maximum possible time steps Tup_{i,k} and Tdn_{i,k}:

FRED: FZL_{i,k,t+Tup}_{_{i,k}}+FZN_{i,k,t+Tup}_{_{i,k}}+SL_{i,k,t}≦1

FRED: FZN_{i,k,t+Tdn}_{_{i,k}}+FZR_{i,k,t+Tdn}_{_{i,k}}+SR_{i,k,t}≦1

6. Exclusive of operating regions in any time step:

A resource can only lie in any one of the regions defined including normal regions and FZs.

$$FBR 1 \text{:} {\sum }_{j ∈ R} {FZN}_{i , j , t} \leq {Y}_{i , t}$$

Wherein the variables include
Y_{i,t} Status of resource i in time step t

In another model, two continuous variables SL_{i,k,t} and SR_{i,k,t} are defined indicating start of FZ from left/right and model the whole FZ ramping limit instead of single interval ramping limit. In some embodiments, this model provides better performance compared to other models described herein.

0. Summation of FZ regions below and above k:

$$FRRS \text{:} {FZR}_{i , k , t} = {\sum }_{j \geq k + 1} {FZN}_{i , j , t}$$

$$FRLS \text{:} {FZL}_{i , k , t} = {\sum }_{j \leq k - 1} {FZN}_{i , j , t}$$

$$0 \leq {FZL}_{i , k , t} , {FZR}_{i , k , t} \leq 1$$

wherein the variables include:
FZN_{i,j,t} Indicator for whether resource i operates within region j in time step t
FZR_{i,k,t} Summary of region status variables for regions above forbidden operating region k in time step t
FZL_{i,k,t} Summary of region status variables for regions below forbidden operating region k in time step t

1. Start of FZ k from right:

If a resource enters FZ k from the right/upper side, then SR_{i,k,t} will be forced to be 1 and 0 otherwise.

FRER1: SR_{i,k,t}≧FZR_{i,k,t-1}−FZR_{i,k,t}

FRER2: SR_{i,k,t}≦FZR_{i,k,t-1}

0≦SR_{i,k,t}≦1

wherein the variables include:
SR_{i,k,t} A continuous variable to indicate whether resource i will cross the forbidden region k from right side (upper regions) in time step t

2. Start of FZ k from left:

If a resource enters FZ k from the left/lower side, then SL_{i,k,t} will be forced to be 1 and 0 otherwise.

FREL1: X_{i,t}+SL_{i,k,t}≧FZL_{i,k,t-1}−FZL_{i,k,t}

FREL2: SL_{i,k,t}≦FZL_{i,k,t-1}

0≦SL_{i,k,t}≦1

wherein the variables include:
SL_{i,k,t} A continuous variable to indicate whether resource i will cross the forbidden region k from left side (lower regions) in time step t
X_{i,t} A binary variable to indicate whether resource i is shutdown in time step t

3. Relationship between SL_{i,k,t} and SR_{i,k,t} for FZ k: A resource can only enter the FZ either from right/upper side or left/lower side of FZ k.

FRST1: SL_{i,k,t}+SR_{i,k,t}≧FZN_{i,k,t}−FZN_{i,k,t-1}

FRST2: SL_{i,k,t}+SR_{i,k,t}≦FZN_{i,k,t}

4. FZ ramping limit for FZ k:

The idea here is to enforce full ramping inside FOR and make a resource stay inside FOR as less number of intervals as possible because FOR is an unstable operating range. For example: assume a resource has 30 min crossing time in applications with time step length of 15 mins, Tup_{i,k} and Tdn_{i,k} will be 2, i.e., the resource will have to stay inside the FZOR region for two intervals no matter how the resource will step inside the FOR region.

FRRU: p_{i,t+Tup}_{_{i,k}}-1−p_{i,t}≧(Tup_{i,k}−1)·ΔP_{i,k}·SL_{i,k,t}−p_{i,t}^{max}·(1·SL_{i,k,t})

FRRD: −p_{i,t+Tdn}_{_{i,k}}-1+P_{i,t}≧(Tdn_{i,k}−1)·ΔP_{i,k}·SR_{i,k,t}−p_{it+Tdn}_{_{i,k}}^{max}·(1−SR_{i,k,t})

wherein the constants include ΔP_{i,k}=RRL_{i,k}^{Up}=RRL_{i,k}^{Dn} is the maximum ramp up and down across the forbidden zone k and

$${Tup}_{i , k} = ⌈ \frac{{P}_{i , k}^{m ax} - {P}_{i , k}^{m i n}}{{RRL}_{i , k}^{up}} ⌉ , {Tdn}_{i , k} = ⌈ \frac{{P}_{i , k}^{m ax} - {P}_{i , k}^{m i n}}{{RRL}_{i , k}^{dn}} ⌉$$

where Tup_{i,k}, Tdn_{i,k} are round up values of FZ crossing time in terms of scheduling time intervals and P_{i,k}^{max}, P_{i,k}^{min} are the upper and lower capacity of forbidden region k.

5. Exit FZ k:

A resource will have to exit the FZ once insider the FOR after the maximum possible time steps Tup_{i,k} and Tdn_{i,k}:

FREU: FZL_{i,k,t+Tup}_{_{i,k}}+FZN_{i,k,t+Tup}_{_{i,k}}+SL_{i,k,t}≦1

FRED: FZN_{i,k,t+Tdn}_{ₖ}+FZR_{i,k,t+Tdn}_{_{i,k}}+SR_{i,k,t}≦1

6. Exclusive of operating regions in any time step, a resource can only lie in any one of the regions defined including normal regions and FZs.

$$FBR 1 \text{:} {\sum }_{j ∈ R} {FZN}_{i , j , t} \leq {Y}_{i , t}$$

wherein the variables include
Y_{i,t} Status of resource i in time step t

The foregoing description discloses only exemplary embodiments of the invention. Modifications of the above disclosed apparatus and methods which fall within the scope of the invention will be readily apparent to those of ordinary skill in the art.

Accordingly, while the present invention has been disclosed in connection with example embodiments thereof, it should be understood that other embodiments may fall within the spirit and scope of the invention, as defined by the following claims.

What is claimed is:

1. A method of operating multi-state resources comprising:
receiving input information including at least one of generator parameters, energy output requirements, fuel cost, fuel availability, and a maintenance schedule;
creating a multi-state resource model based on the input information;
generating an optimized operating schedule from the multi-state resource model based on the input information; and
controlling the multi-state resources to optimally meet energy output requirements using the operating schedule.

2. The method of claim 1 wherein receiving the generator parameters includes receiving the generator parameters from a generator manufacturer.

3. The method of claim 1 wherein creating a multi-state resource model includes creating a multi-state resource model within a modeling system coupled to a system controller.

4. The method of claim 3 further including coupling the system controller to a plurality of multi-state resources corresponding to the generator parameters of the input information.

5. The method of claim 1 further comprising creating a state space enumeration considering a plurality of resource level constraints.

6. The method of claim 5 wherein the plurality of resource level constraints include at least one of mutually exclusive of configurations at any interval, feasible transition matrix, transition time, notification time, no transition at the end of scheduling period, minimum up/down time of multi-state resource configurations and multi-state resource plant, maximum number of transitions and startups, ramping constraints inside a configuration and in transition, resource capacity constraints, and the availability and maintenance schedule of multi-state resources.

7. The method of claim 1 further comprising a validation process to filter out infeasible transition paths based on a multi-state resource initial condition.

8. The method of claim 1 further comprising defining a binary for each feasible transition.

9. The method of claim 8 wherein the feasible transitions include at least one of one configuration to another configuration, one configuration to itself, offline to one configuration, and one configuration to offline.

10. The method of claim 1 further comprising formulating node-balancing equations.

11. The method of claim 10 wherein formulating node-balancing equations includes setting a summation of transitions into a node equal to a summation of transitions outside the node.

12. The method of claim 1 further comprising formulating an objective function considering transition cost and power balance constraints considering transition and startup profile, ramping, and resource capacity constraints.

13. A system for operating multi-state resources comprising:
a plurality of input information sources;
a modeling system including a multi-state resource model operable to generate an operating schedule, the modeling system couplable to the input information sources to receive input information;
a system controller operative to execute the operating schedule and coupled to the modeling system; and
a plurality of multi-state resources coupled to and controlled by the system controller.

14. The system of claim 13 wherein the input information includes at least one of generator parameters, energy output requirements, fuel cost, fuel availability, and a maintenance schedule.

15. The system of claim 13 wherein the multi-state resource model includes a state space enumeration considering a plurality of resource level constraints.

16. A system for operating multi-state resources comprising:
a processor; and
a memory coupled to the processor and storing processor executable instructions to:
receive input information including at least one of generator parameters, energy output requirements, fuel cost, fuel availability, and a maintenance schedule,
create a multi-state resource model based on the input information,
generate an optimized operating schedule from the multi-state resource model based on the input information, and
control the multi-state resources to optimally meet energy output requirements using the operating schedule.

17. The system of claim 16 wherein the instructions further include an instruction to create a state space enumeration considering a plurality of resource level constraints.

18. The system of claim 16 wherein the instructions further include an instruction to filter out infeasible transition paths based on a multi-state resource initial condition.

19. The system of claim 16 wherein the instructions further include an instruction to define a binary for each feasible transition.

20. The system of claim 16 wherein the instructions further include an instruction to formulate node-balancing equations.

21. The system of claim 16 wherein the instructions further include an instruction to formulate an objective function considering transition cost and power balance constraints considering transition and startup profile, ramping, and resource capacity constraints.
